(19) United States
(12) Patent Application Publication
(10) Pub. No.: US 2015/0193446 A1
(43) Pub. Date: Jul. 9, 2015

(54) POINT(S) OF INTEREST EXPOSURE THROUGH VISUAL INTERFACE

(71) Applicant: Microsoft Technology Licensing, LLC, Redmond, WA (US)

(72) Inventors: Donald A. Barnett, Monroe, WA (US); Romualdo T. Impas, Seattle, WA (US); Timothy Phillip Wantland, Bellevue, WA (US); Michael John Bray, Bellevue, WA (US)

(73) Assignee: Microsoft Corporation, Redmond, WA (US)

(21) Appl. No.: 14/149,226

(22) Filed: Jan. 7, 2014

(51) Int. Cl. G06F 17/30; H04L 29/06

(52) U.S. Cl. CPC G06F 17/30061; G06F 17/30696; H04L 67/42

(57) ABSTRACT

One or more techniques and/or systems are provided for exposing one or more points of interest through a visual interface, such as a map. For example, the visual interface may correspond to a location displayed at a first level of detail (e.g., a state level of granularity). One or more points of interest (e.g., coffee shops within the state) may be clustered to generate one or more clustering halos (e.g., a first clustering halo comprising coffee shops within a city), which may be populated within the visual interface. The visual interface may be transitioned into various levels of detail, such as a first transitioned visual interface comprising points of interest at a city level, a second transitioned visual interface comprising points of interest at a building/street level of detail, etc. Portals corresponding to points of interest may be hydrated with imagery for such points of interest.

### BACKGROUND

Many applications and/or websites provide information through visual interfaces, such as maps. For example, a videogame may display a destination for a user on a map; a running website may display running routes through a web map interface; a mobile map app may display driving directions on a road map; a realtor app may display housing information, such as images, sale prices, home value estimates, and/or other information on a map; etc. Such applications and/or websites may facilitate various types of user interactions with maps. In an example, a user may zoom-in, zoom-out, and/or rotate a viewing angle of a map. In another example, the user may mark locations within a map using pinpoint markers (e.g., create a running route using pinpoint markers along the route). In this way, users may view various information and/or perform various tasks through maps.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for exposing one or more points of interest through a visual interface are provided herein. A visual interface, such as a map interface, may be presented. In an example, a mapping service, remote to a client device, may provide mapping information to the client device for display through the map interface (e.g., the client device may display the map interface through a map app, a map website, search results of a search charm and/or other map interfaces that may connect to and/or consume mapping information from the mapping service such as by using mapping service APIs and/or remote HTTP calls). In an example, a client device (e.g., a mobile map app; a running map application executing on a personal computer; etc.) may provide the mapping information for display through the map interface, such as where the mapping information corresponds, for example, to user information (e.g., imagery captured by the user; a saved driving route; a saved search result map; a personal running route map, etc.). The visual interface may correspond to a location displayed at a first level of detail (e.g., a map of California displayed at a state level of detail). One or more points of interest may be associated with the location (e.g., coffee shops, clothing stores, museums, and/or a variety of other points of interest for California).

Because the one or more points of interest may be relatively small to view at the first level of detail, the one or more points of interest within the location may be clustered to generate one or more clustering halos (e.g., a first clustering halo for clothing stores within a first city, a second clustering halo for clothing stores within a second city, a third clustering halo for clothing stores within a third city and a forth city that are adjacent to one another, etc.). In an example, the one or more points of interest within the clustering halo may be treated as a single unit where interaction with the clustering halo is applied to the points of interest within the clustering halo (e.g., zooming into the clustering halo may zoom into the one or more points of interest). In an example, points of interest may be identified for inclusion within a clustering halo based upon a variety of criteria, such as a geo-spatial filter (e.g., points of interest within a threshold distance of one another; points of interest within a threshold distance from a center point; etc.), a point of interest type (e.g., coffee shops may be identified by a first type of clustering halo; coffee farms may be identified by a second type of clustering halo; coffee manufacturing plants may be identified by a third type of clustering halo; etc.), a point of interest density (e.g., once a first clustering halo reaches a density threshold number of points of interest, a second clustering halo may be created and populated with points of interest until the second clustering halo reaches the density threshold, etc.), and/or a variety of other clustering techniques. In an example, the clustering halos may be displayed as translucent halos that may mitigate occlusion of the map. The one or more points of interest may be clustered into the clustering halos to mitigate oversaturation of points of interest that may be otherwise indistinguishable from one another. In this way, the visual interface may be populated with the one or more clustering halos so that a user may explore and/or navigate between points of interest at the first level of detail (e.g., the state level of detail).

Responsive to receiving focus input associated with a clustering halo (e.g., a user may select the first clustering halo for the first city), the visual interface may be transitioned to display a refined location displayed at a second level of detail to create a transitioned visual interface. For example, the transitioned visual interface may display the first city at a city level of detail (e.g., a relatively higher level of granularity and detail than the state level of detail). One or more points of interest within the clustering halo may be clustered to generate one or more halos (e.g., a first halo for clothing stores within a first shopping district of the first city, a second halo for clothing store within a second shopping district of the first city, etc.). The first transitioned visual interface may be populated with the one or more halos. In an example, a halo comprises one or more points of interest that may visually overlap at the second level of detail, and thus the halo may visually outline the one or more points of interest (e.g., FIG. 4B). In an example, a halo may be displayed as a translucent halo to mitigate occlusion. In an example, a display property of a halo and/or points of interest therein may be modified based upon density (e.g., a color of a building comprising a relatively large number of doctor office points of interest may be modified to indicate the high density of points of interest (e.g., which otherwise may not be noticeable due to the doctor office points of interest being stacked upon one another within the building); the doctor office points of interest may be displayed in a skew manner to avoid occlusion; a point of interest having a relatively low relevancy rank (e.g., a gas station store corresponding to a shopping search query) may be removed from the halo to avoid occlusion of relatively higher ranked points of interest (e.g., a clothing store corresponding to the shopping search query)). In an example, a halo may be hydrated with imagery depicting a corresponding point of interest within the halo (e.g., a user may “flip” through multiple images (e.g., presented, ordered, etc. based upon relevancy rankings) that correspond to a particular point of interest within the halo (e.g., responsive to the user clicking on or otherwise interacting with that particular point of interest)). The halo may be resized; a color of the halo may be modified; an opaque property of the halo may be modified; etc., such as, for example, based upon focus input associated with the halo (e.g., rollover input). In this way, the user may explore, preview, and/or navigate between points of interest (e.g., and/or imagery associated therewith) at the second level of detail (e.g., the city level of detail). In an example, as a user zooms into a halo, the halo may diminish and a point of interest within the halo may become bigger and/or may transition into a portal.

Responsive to receiving focus input associated with a halo for a point of interest, the first transitioned visual interface may be transitioned to display a second refined location at a third level of detail to create a second transitioned visual interface. It may be appreciated that a visual interface (e.g., the first transitioned visual interface, the second transitioned visual interface, etc.) may be zoomed into and/or zoomed out of in a continuous (e.g., analog) manner, such that points of interest become larger and/or smaller. At a certain level of zooming in, a point of interest may become a portal that may be hydrated. To hydrate a portal, for example, a display property of a portal user interface element may be set to an image depicting the corresponding point of interest. For example, an image having a relatively high rank assigned by an image service may be selected to hydrate the portal (e.g., an image search engine may rank the image based upon a relevance to the corresponding point of interest). The second transitioned visual interface may be populated with one or more portals corresponding to points of interest within the second refined location (e.g., clothing stores within a first shopping district of the first city). For example, a first portal may correspond to a first clothing store, a second portal may correspond to a second clothing store, etc.

Responsive to receiving focus input for a portal (e.g., a rollover input for the portal and/or a panning input that positions the portal at a trigger zone within the second transitioned visual interface, such as a center zone), the portal may be hydrated with imagery depicting a corresponding point of interest (e.g., the first portal may be hydrated with imagery of the first clothing store). In this way, the user may explore, preview, and/or navigate between points of interest at the third level of detail (e.g., a street-side level of detail). Cluster points of interest and/or populating a visual interface with clustering halos, halos, portals, and/or other interface elements, may mitigate occlusion of an underlying visualization, such as a map, displayed through the visual interface (e.g., visual effects, such as translucency, and/or levels of detail may be dynamically adjusted so that a user may view the underlying visualization and/or distinguish between points of interest). Hydrating a halo and/or a portal with imagery may allow a user to “preview” a point of interest without transitioning away from a current location or view. The user may spread apart, zoom into, and/or navigate between points of interest to disambiguate relatively large amounts of points of interest. In this way, a single dynamic and scaling solution is provided for way finding, exploring, discovering, storytelling, searching, and/or researching over a visual interface. It will be appreciated that a visual interface and/or the like corresponds to, comprises, etc. any number of interfaces, such as a map, a photograph, an object, a panorama, etc. and is not meant to be limited by the examples provided herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of exposing one or more points of interest though a visual interface.

FIG. 2 is a flow diagram illustrating an exemplary method of exposing one or more points of interest though a visual interface.

FIG. 3 is a component block diagram illustrating an exemplary system for exposing one or more points of interest through a visual interface.

FIG. 4A is a component block diagram illustrating an exemplary system for exposing one or more points of interest through a first transitioned visual interface.

FIG. 4B is an illustration of an example of a halo.

FIG. 5 is a component block diagram illustrating an exemplary system for exposing one or more points of interest through a second transitioned visual interface.

FIG. 6 is a component block diagram illustrating an exemplary system for hydrating a portal with imagery.

FIG. 7 is a component block diagram illustrating an exemplary system for hydrating a portal with imagery.

FIG. 8 is a component block diagram illustrating an exemplary system for facilitating navigation between visual interfaces.

FIG. 9 is an illustration of an example of populating a visual interface with one or more clustering halos according to a continental level of detail.

FIG. 10 is an illustration of an example of populating a visual interface with one or more clustering halos according to a city level of detail.

FIG. 11 is an illustration of an exemplary computer readable medium wherein processor-executable instructions configured to embody one or more of the provisions set forth herein may be comprised.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for exposing one or more points of interest through a visual interface are provided. For example, points of interest may clustered, organized, distinguishable (e.g., visibly and/or interactively) and/or exposed through halos and/or portals to improve user visualization and/or navigation, such as through touch interaction, of such points of interest. When a location displayed through a visual interface comprises a substantial or threshold number of points of interest, the points of interest may be clustered into clustering halos to mitigate occlusion of an underlying visualization populated within the visual interface. As the visual interface is transitioned to, such as zoomed into, refined locations having a relatively smaller number of points of interest, the points of interest may be clustered into halos that may facilitate user interaction, navigation, and/or exploration of such points of interest. In an example, a halo may be hydrated with imagery of a point of interest that is clustered into the halo (e.g., a point of interest within a particular location or zone of the halo). In an example, a point of interest may be transitioned into a portal based upon zooming input for the point of interest (e.g., the point of interest may be zoomed into a zoom level greater than a transition threshold). In another example, a portal may be displayed for a point of interest based upon user interaction with the point of interest. In this way, the user may navigate between and/or explore points of interest at various levels of granularity and/or detail.

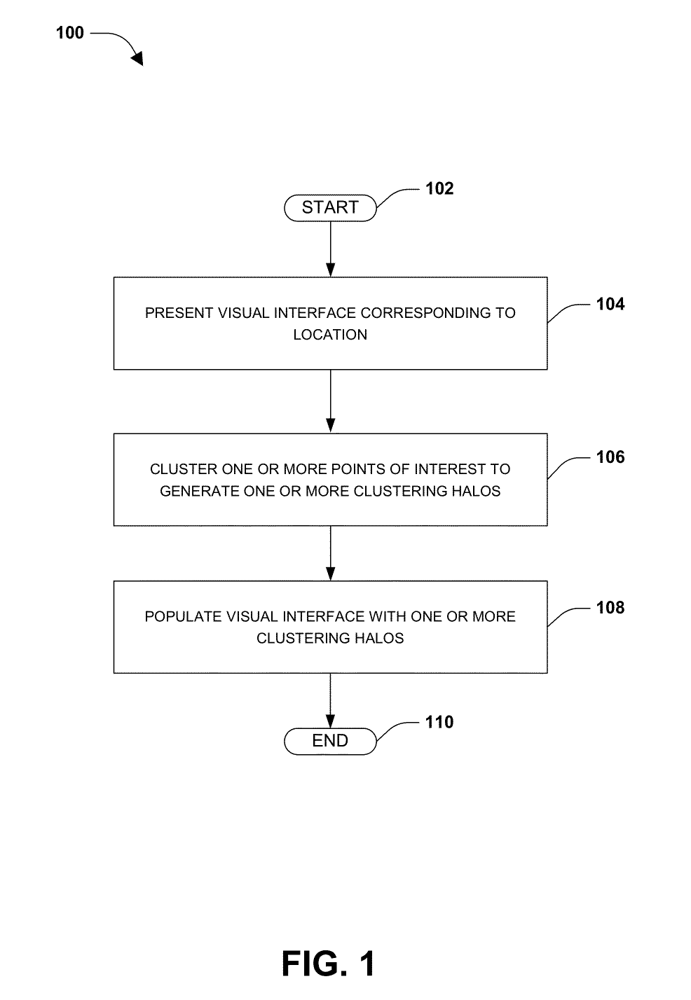

An embodiment of exposing one or more points of interest though a visual interface is illustrated by an exemplary method 100 of FIG. 1. At 102, the method starts. At 104, a visual interface may be presented. The visual interface may correspond to a location displayed at a first level of detail. For example, the visual interface may display a map of the Eastern United States. At 106, one or more points of interest associated with the location may be clustered to generate one or more clustering halos, such as a first clustering halo comprising a first cluster of points of interest that are clustered based upon location (e.g., the first clustering halo may comprise one or more stores within a first city; a second clustering halo may comprise one or more stores within a second city; etc.). In an example, the location and/or the one or more points of interest correspond to a single topic query (e.g., a user may submit a query “shopping in the Eastern United States” relating to shopping points of interest). In another example, the location and/or the one or more points of interest may correspond to a multi-topic query (e.g., a user may submit a query “Eastern United States” relating to a wide variety of points of interest for the Eastern United States, such as museums, parks, buildings, stores, etc.). At 108, the visual interface may be populated with the one or more clustering halos. Because the one or more points of interest (e.g., thousands of points of interest) may be clustered into the one or more clustering halos, the map of the Eastern United States may be viewable to a user with reduced occlusion.

User exploration of the one or more points of interest, such as zoom navigation into a higher level of detail, may be facilitated. In an example, a first focus input associated with the first clustering halo may be received (e.g., a user may select the first clustering halo, such as through touch interaction). The visual interface may be transitioned to display a first refined location displayed at a second level of detail to create a first transitioned visual interface (e.g., the first transitioned visual interface may be displayed at a city level of detail providing a relatively higher level of detail than the first level of detail used to display the Eastern United States within the visual interface). For example, the first transitioned visual interface may display the first city associated with the first clustering halo. One or more points of interest within the first clustering halo (e.g., points of interest within the first city) may be clustered to generated one or halos, such as a first halo comprising a first refined cluster of points of interest (e.g., the first halo may comprise shops within a first shopping district of the first city; a second halo may comprise shops within a second shopping district of the first city; etc.). The first transitioned visual interface may be populated with the one or more halos. In an example, the one or more halos may be displayed as translucent halos to mitigate occlusion of the first city displayed through first transitioned visual interface. In an example, user navigation may be facilitated by populating the first transitioned visual interface with a back interface element. The back interface element may be configured to transition the first transitioned visual interface to the visual interface corresponding to the location (e.g., the first transitioned visual interface, displaying the first city, may be transitioned to the visual interface displaying the Eastern United States according to an orientation of the visual interface before the visual interface was transitioned to the first transitioned interface). A back interface element may merely comprise an ability to click, touch, gesture, etc. outside of, in a peripheral portion of, etc. a presently presented visual interface to be taken back to a previously presented visual interface.

In an example, a user may interact with and/or explore a point of interest clustered within a halo of the first transitioned visual interface. For example, responsive to receiving second focus input associated with a first point of interest within the first halo (e.g., the user may pan the first transitioned visual interface and/or the first halo so that the first halo encounters a trigger zone; the user may select the first point of interest within the first halo; etc.), a display property of the first point of interest may be modified. In an example, a view of the first point of interest may be zoomed into and/or other points of interest may be dispersed or spread away from the first point of interest. In another example, a size of the first point of interest may be modified to distinguish the first point of interest from other points of interest within the first halo. In another example, an opaque property of the first point of interest may be modified to distinguish the first point of interest from other points of interest within the first halo. In another example, a color of the first point of interest may be modified to distinguish the first point of interest from other points of interest within the first halo. In another example, the first halo may be hydrated with imagery depicting the first point of interest (e.g., a photo extracted from a social network; a street-side photo; a panorama stitched together from multiple images; a 3D visualization of the first point of interest; etc.).

A user may explore and/or zoom into a halo. For example, responsive to second focus input associated with the first halo, the first transitioned visual interface may be transitioned to display a second refined location at a third level of detail to create a second transitioned visual interface (e.g., the second refined location, such as the first shopping district, may be displayed at a street-side level of detail having a relatively higher level of detail than the city level of detail used in the first transitioned visual interface to display the first city). The second transitioned visual interface may be populated with one or more portals corresponding to points of interest associated with the second location, such as the first shopping district. For example, the second transitioned visual interface, depicting the first shopping district, may be populated with a first portal corresponding to a first point of interest (e.g., a clothing store), a second portal corresponding to a second point of interest (e.g., a videogame store), a third portal corresponding to a third point of interest (e.g., a coffee shop), etc.

A user may explore points of interest associated with portals. In an example, responsive to receiving focus input associated with the first portal (e.g., rollover input or panning input positioning the first portal at a trigger zone within the second transitioned visual interface), the first portal may be hydrated with imagery depicting the first point of interest such as the clothing store (e.g., photos associated with the user, photos associated with other users such as users of a photo sharing social network, images of articles for sale from the clothing store, advertisements associated with the clothing store, coupons associated with the clothing store, etc.). In another example, responsive to receiving panning input associated with the second transitioned visual interface (e.g., a carousel display effect), portals that encounter a trigger zone (e.g., a center zone or central area, etc.) of the second transitioned visual interface may be hydrated while such portals encounter the trigger zone and may be collapsed responsive to such portals no longer encountering the trigger zone. In this way, a user may visually navigate between points of interest while differentiating between such points of interest.

A user may navigate and/or zoom into portals to explore various points of interest. In an example, responsive to receiving focus input associated with the first portal displaying the first point of interest, such as the clothing store (e.g., a selection of the first portal), the second transitioned visual interface may be transitioned to display the first point of interest at a fourth level of detail to create a third transitioned visual interface (e.g., a building level of detail). For example, the third transitioned visual interface may display the clothing store. The third transitioned visual interface may be populated with one or more new portals corresponding to points of interest within the clothing store, such as a first new portal for a second floor of the clothing store, a second new portal for a backdoor to a street behind the clothing store, a third new portal for a checkout counter for the clothing store, etc. In this way, the user may continue to navigate and/or explore points of interest at various levels of detail (e.g., clustering halos for points of interest at a national scale; halos for points of interest at a city level; new portals for points of interest at a building level; etc.). At 110, the method ends.

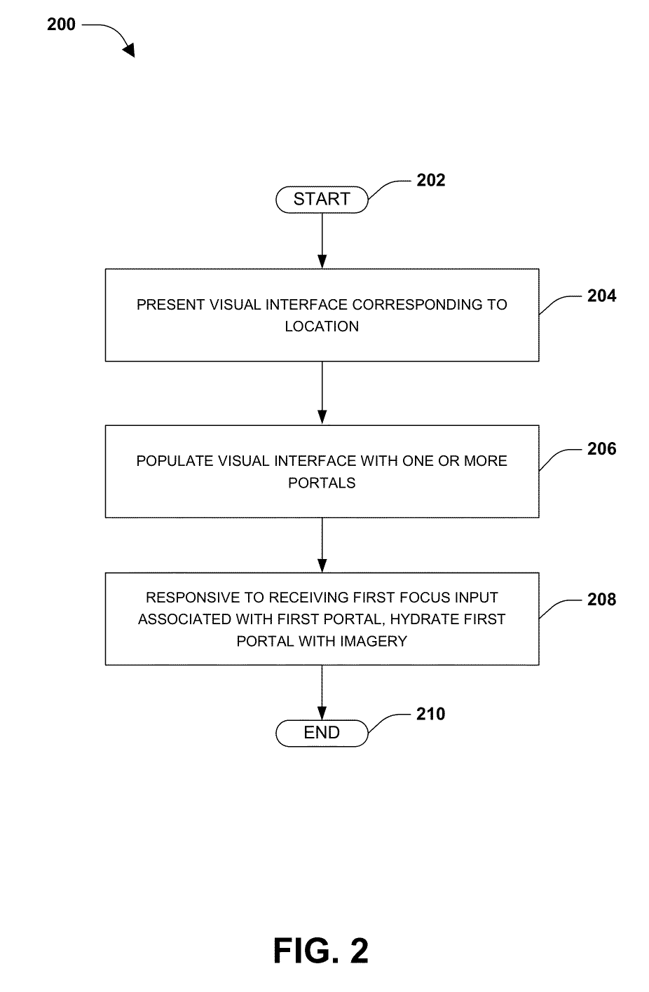

An embodiment of exposing one or more points of interest though a visual interface is illustrated by an exemplary method 200 of FIG. 2. At 202, the method starts. At 204, a visual interface corresponding to a location may be presented. For example, the visual interface may display a map of a shopping mall. At 206, the visual interface may be populated with one or more portals corresponding to points of interest for the location. For example, a first portal may correspond to a first point of interest, such as a videogame store within the shopping mall. At 208, responsive to receiving first focus input associated with the first portal (e.g., a rollover input or a panning input that positions the first portal at a trigger zone within the visual interface), the first portal may be hydrated with imagery depicting the first point of interest (e.g., the first portal may be populated with an interactive panorama of the videogame store, such that a user may pan, zoom, and/or navigate around the view of the videogame store through the first portal). In an example, responsive to receiving second focus input associated with the first portal, the visual interface may be transitioned to display the first point of interest to create a first transitioned visual interface for a refined location (e.g., the videogame store). The first transitioned visual interface may be populated with one or more portals corresponding to points of interest within the refined location. For example, a back door portal that opens to a street behind the videogame store, an upstairs portal that leads to a second floor, a videogame console kiosk portal, etc. In this way, the user may navigate between points of interest (e.g., the user may travel to the street behind the videogame store by interacting with the back door portal) and/or preview points of interest before navigation (e.g., the upstairs portal may be hydrated with imagery of the second floor). At 210, the method ends.

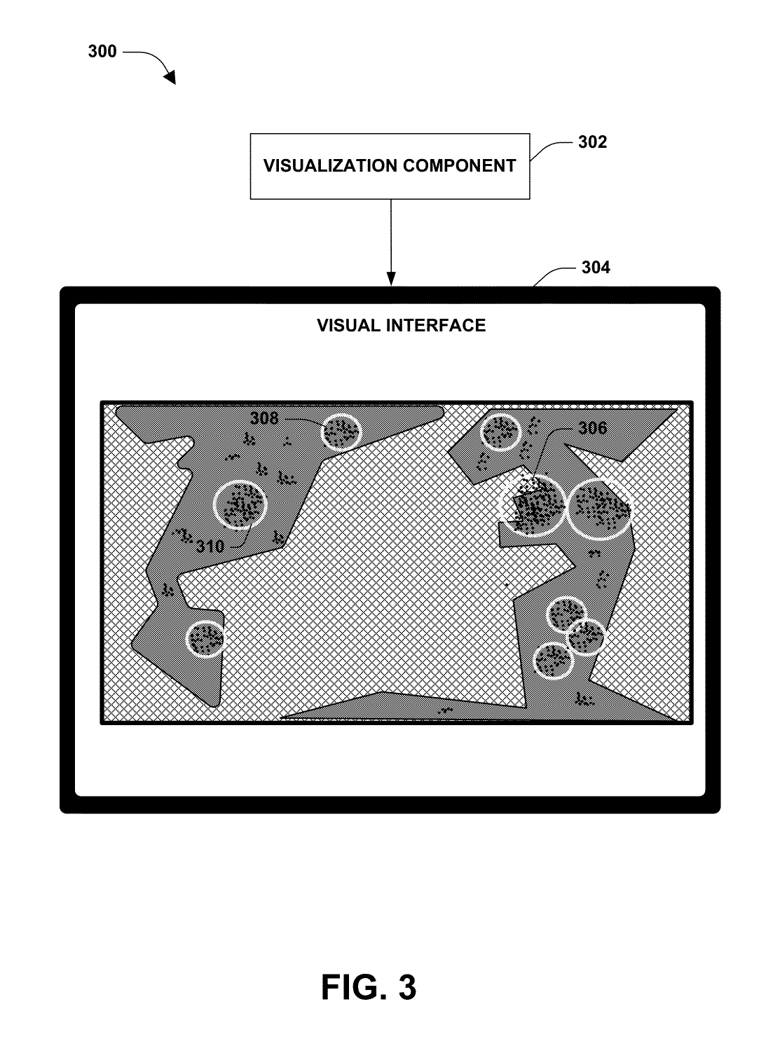

FIG. 3 illustrates an example of a system 300 for exposing one or more points of interest through a visual interface 304. The system 300 may comprise a visualization component 302. The visualization component 302 may be configured to present the visual interface 304 corresponding to a location displayed at a first level of detail. For example, the visual interface 304 may correspond to two island countries separated by an ocean (e.g., the first level of detail may be at a national scale). In an example, the visualization component 302 may be implemented within a client device through which the visual interface 304 is displayed (e.g., a personal computer, a tablet, a GPS device, a mobile device, etc.). In this way, a client-side implementation is contemplated. In another example, the visualization component 302 may be implemented within a mapping server remotely accessible to a client device that may display the visual interface 304 (e.g., the client device may display the visual interface 304 through a web browser accessing a mapping website associated with the mapping server; the client device may display the visual interface 304 through a map app on a mobile device that may remotely access the mapping server utilizing various protocols (e.g., HTTP) and/or API calls, etc.). The visualization component 302 may push and/or cache map information and/or map rendering information (e.g., vectors) to the client device. For example, the client device may send a search query for restaurants to the mapping server. The mapping server may apply one or more filters (e.g., a restaurant filter, a current location filter for the client device, a user restaurant preference filter, etc.) to map data to create mapping information that may be provided to the client device for display. In this way, a client/server configuration is contemplated.

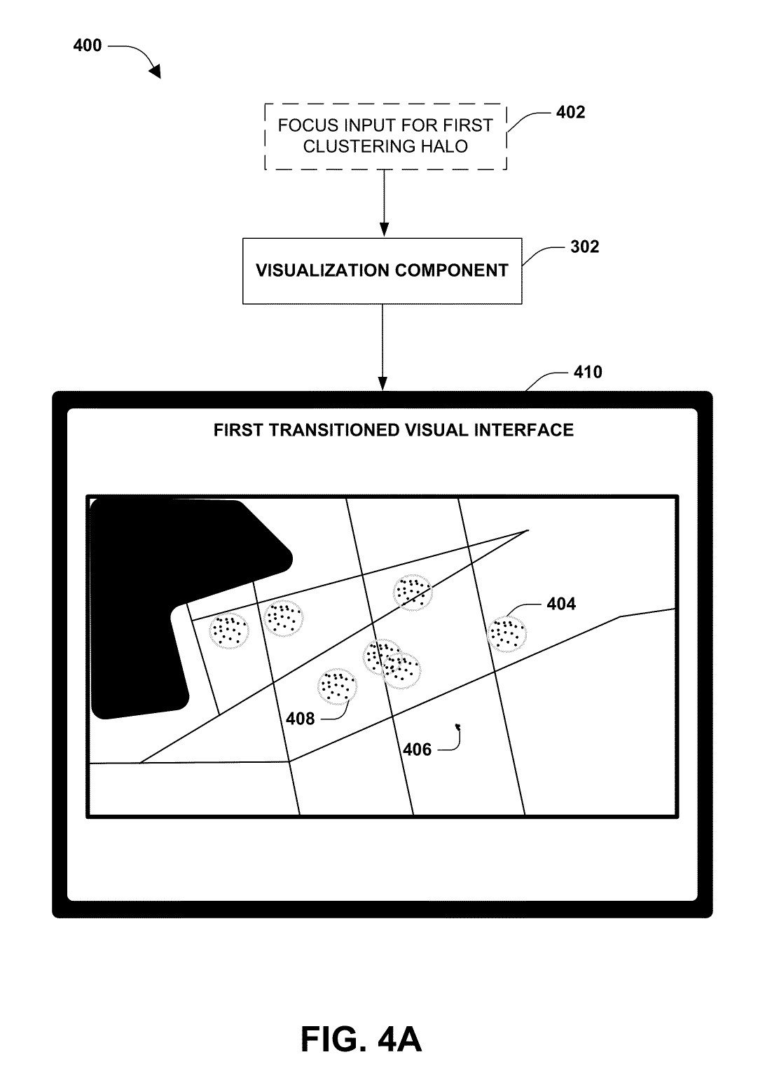

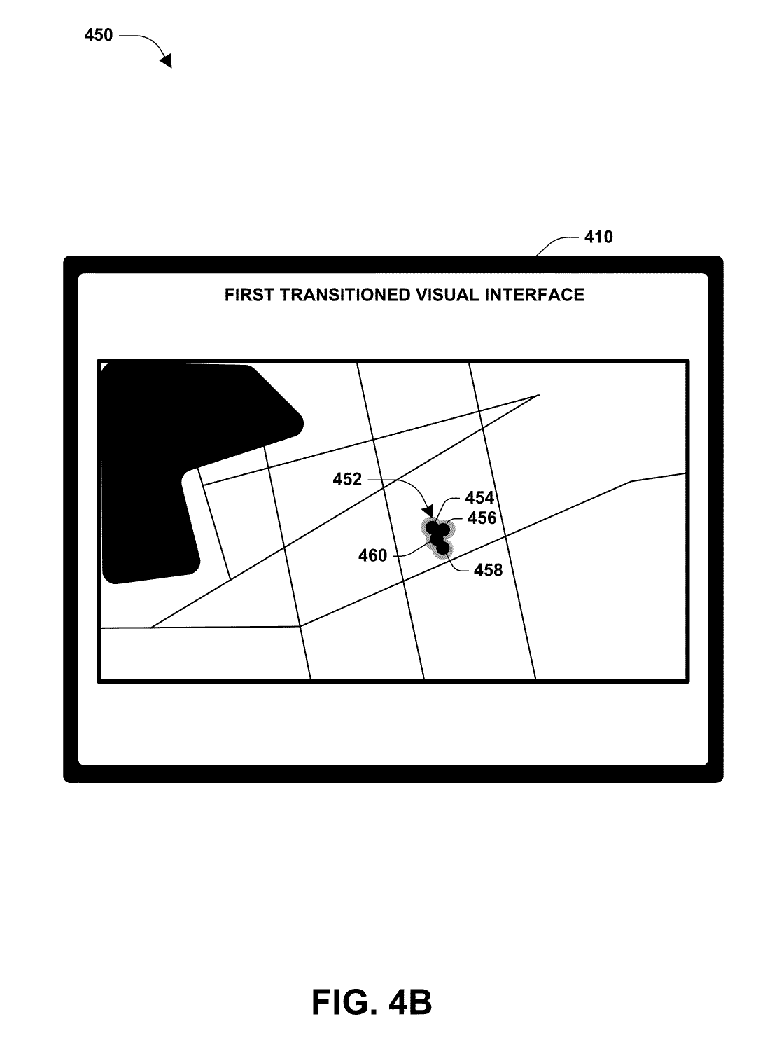

One or more points of interest associated with the location may be clustered to generate one or more clustering halos, such as a first clustering halo 306, a second clustering halo 308, a third clustering halo 310, and/or other clustering halos. For example, the first clustering halo 306 may comprise one or more points of interest within a first city, the second clustering halo 308 may comprise one or more points of interest within a second city, the third clustering halo 301 may comprise one or more points of interest within a third city, etc. In an example, the first clustering halo 306, the second clustering halo 308, and/or the third clustering halo 310 are displayed as translucent halos to mitigate occlusion of a map of the two island countries displayed through the visual interface 304. In an example, the one or more points of interest may be represented as individual elements, such as dots, based upon the first level of detail (e.g., display of the one or more points of interest may be dynamically modified based upon a current level of detailed displayed through the visual interface 304, such as a city level of detail or street-side level of detail). Responsive to receiving focus input associated with the first halo 306, the visualization component 302 may transition the visual interface 304 to display a first refined location (e.g., the first city) displayed at a second level of detail to create a first transitioned visual interface (e.g., FIG. 4).

FIG. 4A illustrates an example of a system 400 for exposing one or more points of interest through a first transitioned visual interface 410. The system 400 may comprise a visualization component 302. In an example, the visualization component 302 may have presented a visual interface 304 associated with a location, such as a location corresponding to two island countries separated by an ocean (e.g., FIG. 3). The visualization component 302 may receive focus input 402 for a first clustering halo 306 within the visual interface 304 (e.g., a user may select the first clustering halo 306). Accordingly, the visualization component 302 may transition the visual interface 304 to display a first refined location (e.g., a first city corresponding to the first clustering halo 306) at a second level of detail (e.g., a city level of detail) to generate the first transitioned visual interface 410. The visualization component 302 may populate the first transitioned visual interface 410 with one or more halos, such as a first halo 404 corresponding to one or more points of interest (e.g., stores, buildings, or other points of interest along a first street), a second halo 406 corresponding to one or more points of interest (e.g., points of interest within a park), a third halo 408 corresponding to one or more points of interest (e.g., points of interest along a second street), etc. In this way, a user may navigate and/or zoom into points of interest from the first level of detail of the visual interface 304 to the second level of detail for the first transitioned visual interface 410.

It may be appreciated that halos may be displayed according to various shapes, sizes, and/or configurations, as illustrated in example 450 of FIG. 4B. For example, one or more points of interest, such as a first point of interest 454, a second point of interest 456, a third point of interest 458, a fourth point of interest 460, and/or other points of interest, may be grouped into a halo 452. In an example, one or more other points of interest may be filtered from display through the halo 452 based upon such points of interest having relatively less relevancy to a user (e.g., a fifth point of interest may be excluded from display through the halo 452 based upon a collision detection technique determining that the fifth point of interest, such as a gas station point of interest, may be relatively less relevant to a user searching for shopping malls). In an example, the one or more points of interest may be grouped based upon a clustering algorithm, such as a geo-spatial filtering algorithm that groups points of interest based upon locational similarity, a point of interest type algorithm that groups points of interest based upon types (e.g., parking lot points of interest, shopping mall points of interest, gas station points of interest, etc.), a density algorithm that groups points of interest within a halo until a density threshold is exceed (e.g., then a new halo may be created), and/or other algorithms that may be implemented by the mapping service. For example, a mapping server, remotely accessible to a client device that displays visual interfaces (e.g., the first transitioned visual interface 410), may push mapping information to the client device for display. The halo 452 may have a shape defined by the one or more points of interest (e.g., the halo 452 may outline the one or more points of interest). The one or more points of interest within the halo 452 may be treated as a single unit such that input (e.g., user interaction; zoom input; panning input; selection input; etc.) with the halo 452 may be applied to the one or more points of interest.

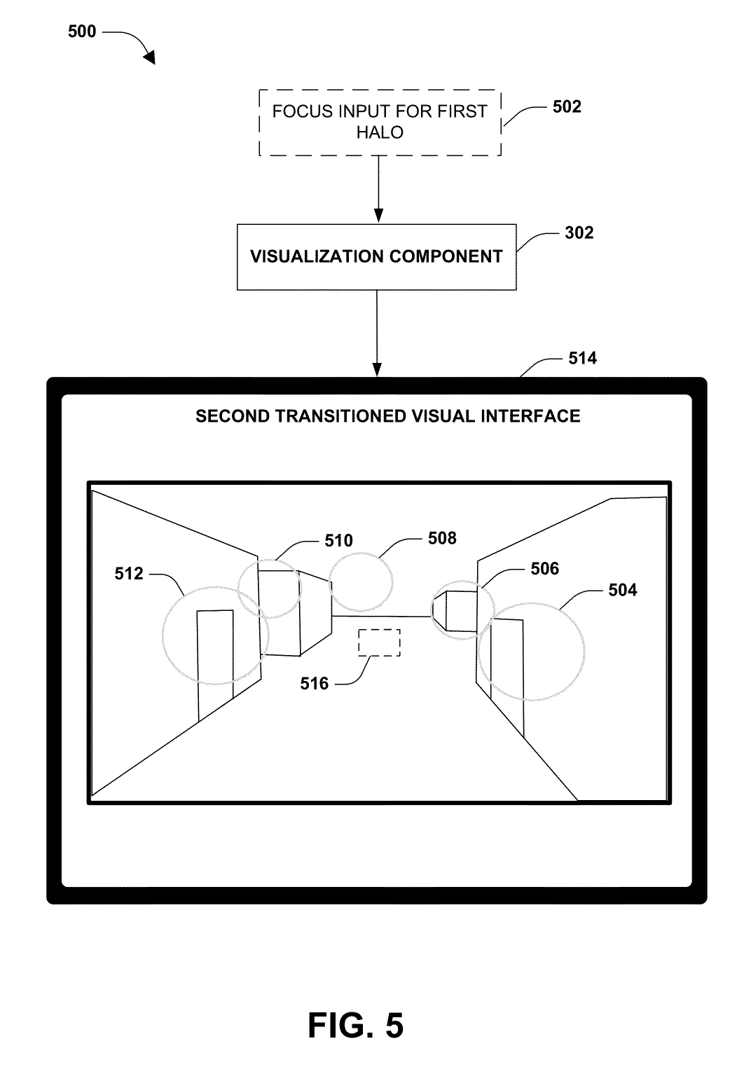

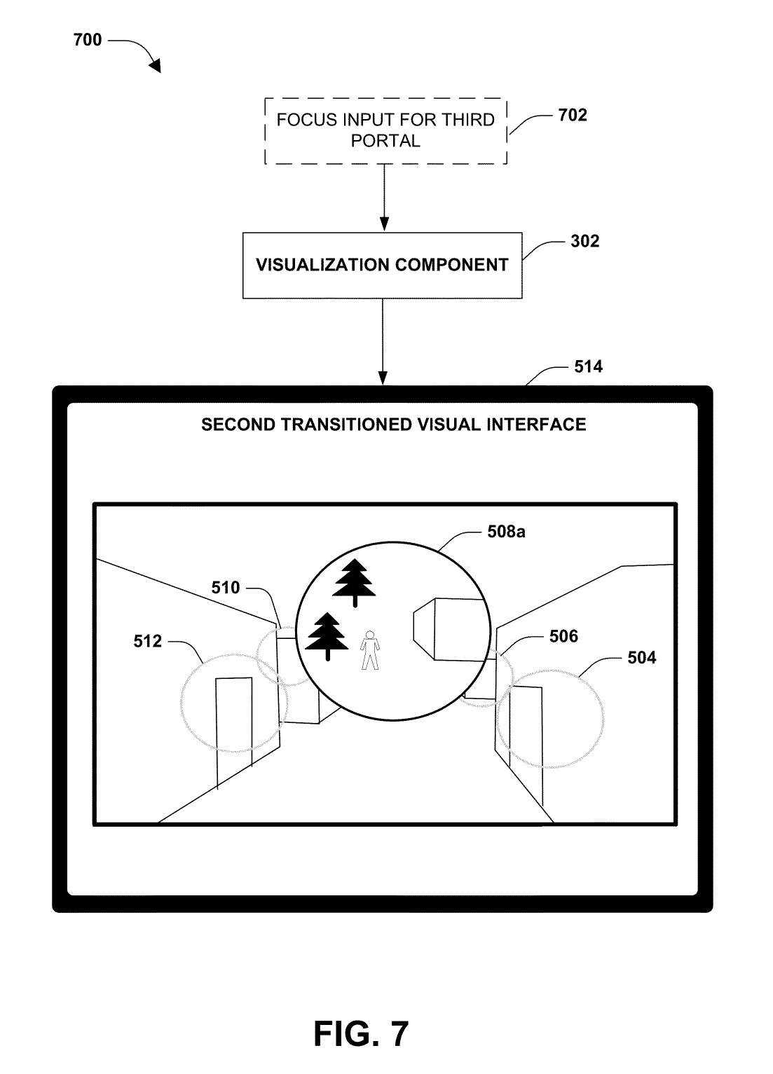

FIG. 5 illustrates an example of a system 500 for exposing one or more points of interest through a second transitioned visual interface 514. The system 500 may comprise a visualization component 302. In an example, the visualization component 302 may have presented a visual interface 304 associated with a location (e.g., two island countries) (e.g., FIG. 3), and may have transitioned the visual interface 304 to display a first refined location (e.g., a first city) to create a first transitioned visual interface 410 populated with one or more halos comprising clusters of points of interest (e.g., FIG. 4). The visualization component 302 may receive focus input 502 for a first halo 404 within the first transitioned visual interface 410 (e.g., a user may select the first halo 404). Accordingly, the visualization component 302 may transition the first transitioned visual interface 410 to display a second refined location (e.g., a shopping mall building within the first city) at a third level of detail (e.g., a building level of detail) to generate the second transitioned visual interface 514. The visualization component 302 may populate the second transitioned visual interface 514 with one or more portals, such as a first portal 504 corresponding to a first point of interest (e.g., a first store within the shopping mall building), a second portal 506 corresponding to a second point of interest (e.g., a second store within the shopping mall building), a third portal 508 corresponding to a third point of interest (e.g., a first hallway to an outdoor portion of the shopping mall building), a fourth portal 510 corresponding to a fourth point of interest (e.g., a second hallway to a third portion of the shopping mall building), a fifth portal 512 corresponding to a fifth point of interest (e.g., a third store within the shopping mall building), etc. In this way, the user may navigate and/or explore points of interest at various levels of detail. In an example, the second transitioned visual interface 514 may comprise a target zone 516. The visualization component 302 may be configured to hydrate a portal with imagery based upon the portal encountering the target zone 516 (e.g., FIG. 7).

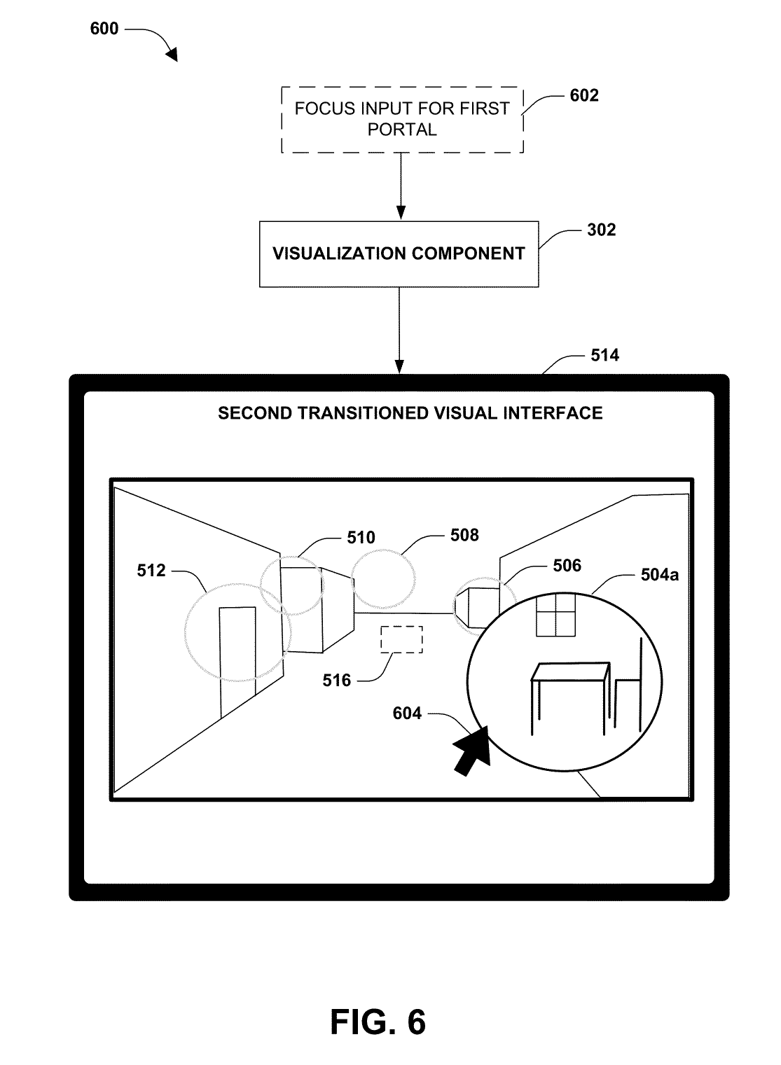

FIG. 6 illustrates an example of a system 600 for hydrating a portal with imagery. The system 600 may comprise a visualization component 302. In an example, the visualization component 302 may have presented a second transitioned visual interface 514 populated with one or more portals corresponding to points of interest for a second refined location (e.g., a shopping mall building) (e.g., FIG. 5). The visualization component 302 may receive focus input 602 for a first portal 504 (e.g., the user may touch, mouseover 604, etc. the first portal 504). Accordingly, the visualization component 302 may hydrate the first portal 504 with imagery of a first point of interest such as a first store within the shopping mall building to create a first hydrated portal 504a (e.g., illustrating a table, chair, etc. for sale). In this way, the user may preview and/or explore the first store without transitioning away from the shopping mall building view of the second transitioned visual interface 514.

FIG. 7 illustrates an example of a system 700 for hydrating a portal with imagery. The system 700 may comprise a visualization component 302. In an example, the visualization component 302 may have presented a second transitioned visual interface 514 populated with one or more portals corresponding to points of interest for a second refined location (e.g., a shopping mall building) (e.g., FIG. 5). The visualization component 302 may receive focus input 702 for a third portal 508 (e.g., the user may navigate, such as pan, the second transitioned visual interface 514 such that the third portal 508 encounters a trigger zone 516, illustrated in FIG. 5). Accordingly, the visualization component 302 may hydrate the third portal 508 with imagery of a third point of interest, such as an outdoor portion of the shopping mall building, to create a third hydrated portal 508a. In this way, the user may preview and/or explore the first store without transitioning away from the shopping mall building view of the second transitioned visual interface 514.

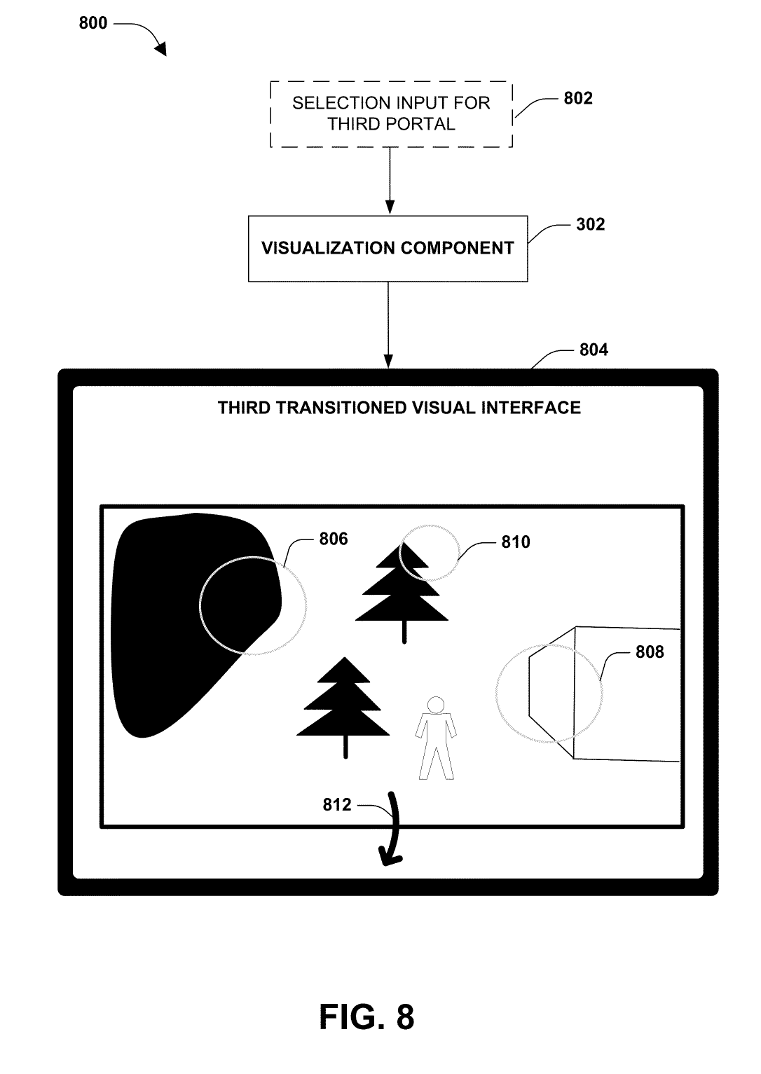

FIG. 8 illustrates an example of a system 800 for facilitating navigation between visual interfaces. The system 800 may comprise a visualization component 302. In an example, the visualization component 302 may have presented a second transitioned visual interface 514 populated with one or more portals corresponding to points of interest for a second refined location (e.g., a shopping mall building) (e.g., FIG. 5). The visualization component 302 may receive selection input 802 for a third portal 508 (e.g., the user may select the third portal 508, corresponding to an outdoor portion of the shopping mall building, within the second transitioned visual interface 514). Accordingly, the visualization component 302 may transition the second transitioned visual interface 514 to display a third refined location (e.g., the outdoor portion of the shopping mall building) at a fourth level of detail (e.g., a building level of detail) to generate the third transitioned visual interface 804. The visualization component 302 may populate the third transitioned visual interface 804 with one or more portals, such as a first portal 806 corresponding to a first point of interest (e.g., a water feature within the outdoor portion of the shopping mall building), a second portal 808 corresponding to a second point of interest (e.g., a store within the outdoor portion of the shopping mall building), a third portal 810 corresponding to a third point of interest (e.g., a tree feature within the outdoor portion of the shopping mall building), etc. The third transitioned visual interface 804 may be populated with a back interface element 812. Responsive to invocation of the back interface element 812, the third transitioned visual interface 804 may be transitioned to the second transitioned visual interface 514 (e.g., the second transitioned visual interface 514 may be displayed according to an orientation of the second transitioned visual interface 514 before the second transitioned visual interface 514 was transitioned to the third transitioned visual interface 804). In this way, the user navigate and/or explore points of interest at various levels of detail.

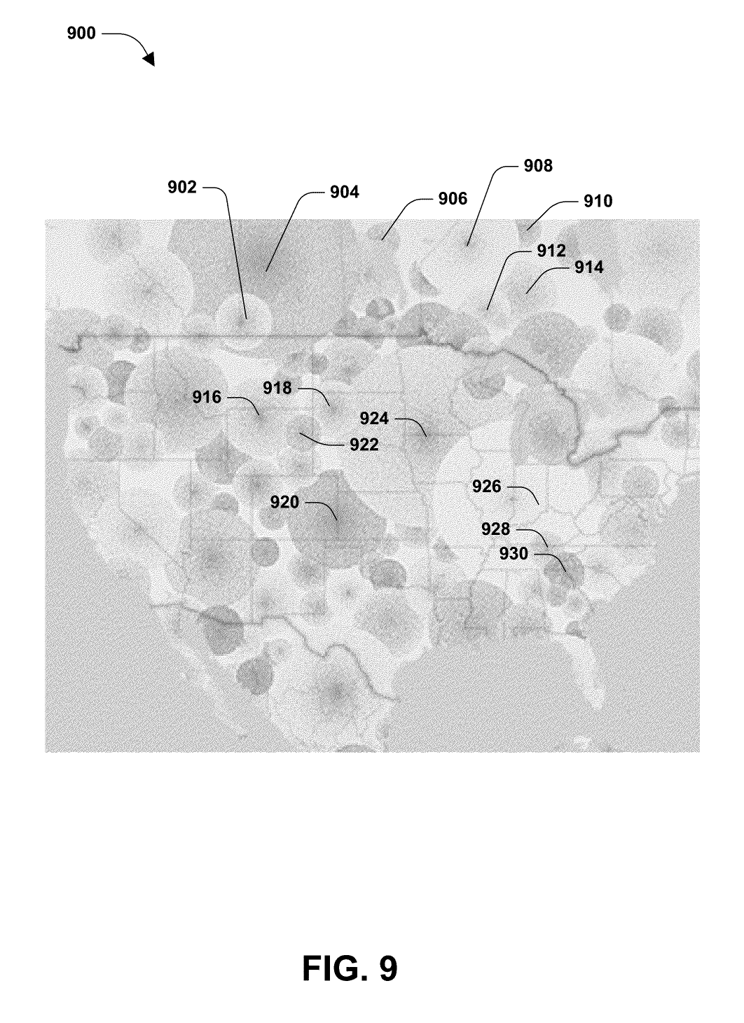

FIG. 9 illustrates an example of populating a visual interface 900 with one or more clustering halos according to a continental level of detail. For example, the visual interface 900 may correspond to a map of North America. The visual interface may be populated with one or more clustering halos corresponding to points of interest within North America (e.g., coffee shops). For example, the visual interface 900 may be populated with a first clustering halo 902, a second clustering halo 904, a third clustering halo 906, a fourth clustering halo 908, a fifth clustering halo 910, a sixth clustering halo 912, a seventh clustering halo 914, an eighth clustering halo 916, a ninth clustering halo 918, a tenth clustering halo 920, an eleventh clustering halo 922, a twelfth clustering halo 924, a thirteenth cluster halo 926, a fourteenth clustering halo 928, a fifteenth clustering halo 930, and/or other overlapping clustering halos and/or non-overlapping clustering halos. In this way, the user may navigate and/or explore points of interest at various levels of detail, such as the continental level of detail.

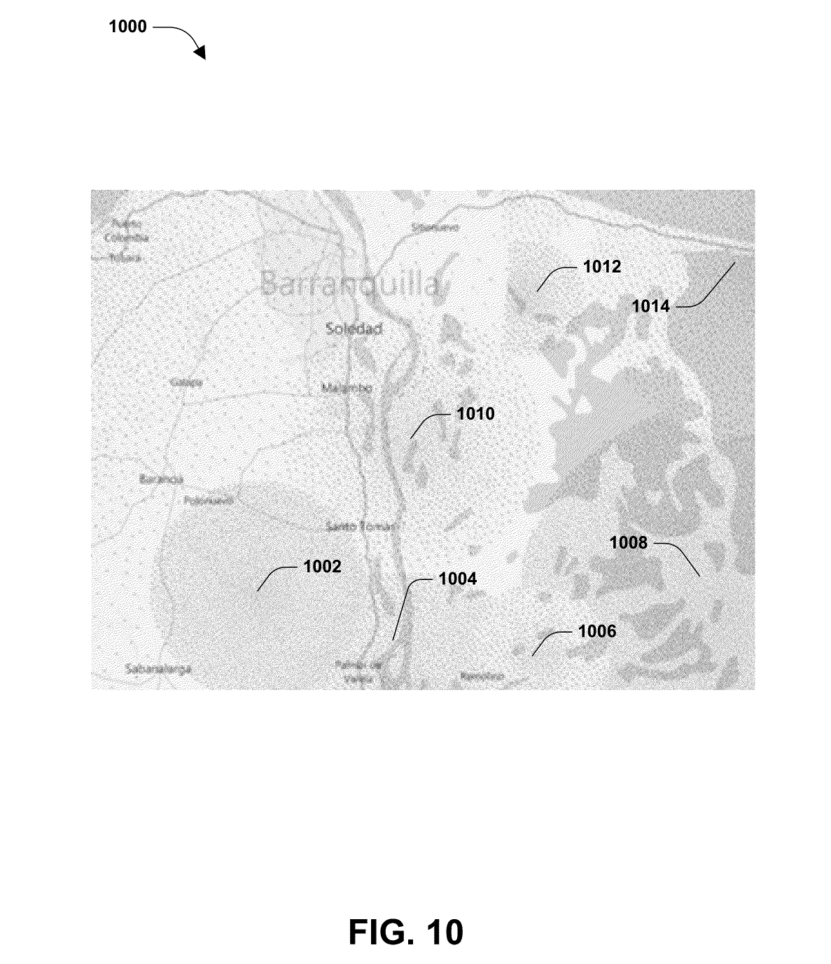

FIG. 10 illustrates an example of populating a visual interface 1000 with one or more clustering halos according to a city level of detail. For example, the visual interface 1000 may correspond to a map of a city, Barranquilla. The visual interface 1000 may be populated with one or more clustering halos corresponding to points of interest within Barranquilla (e.g., coffee shops). For example, the visual interface 1000 may be populated with a first clustering halo 1002, a second clustering halo 1004, a third clustering halo 1006, a fourth clustering halo 1008, a fifth clustering halo 1010, a sixth clustering halo 1012, a seventh clustering halo 1014, and/or other overlapping clustering halos and/or non-overlapping clustering halo. In this way, the user may navigate and/or explore points of interest at various levels of detail, such as the city level of detail.

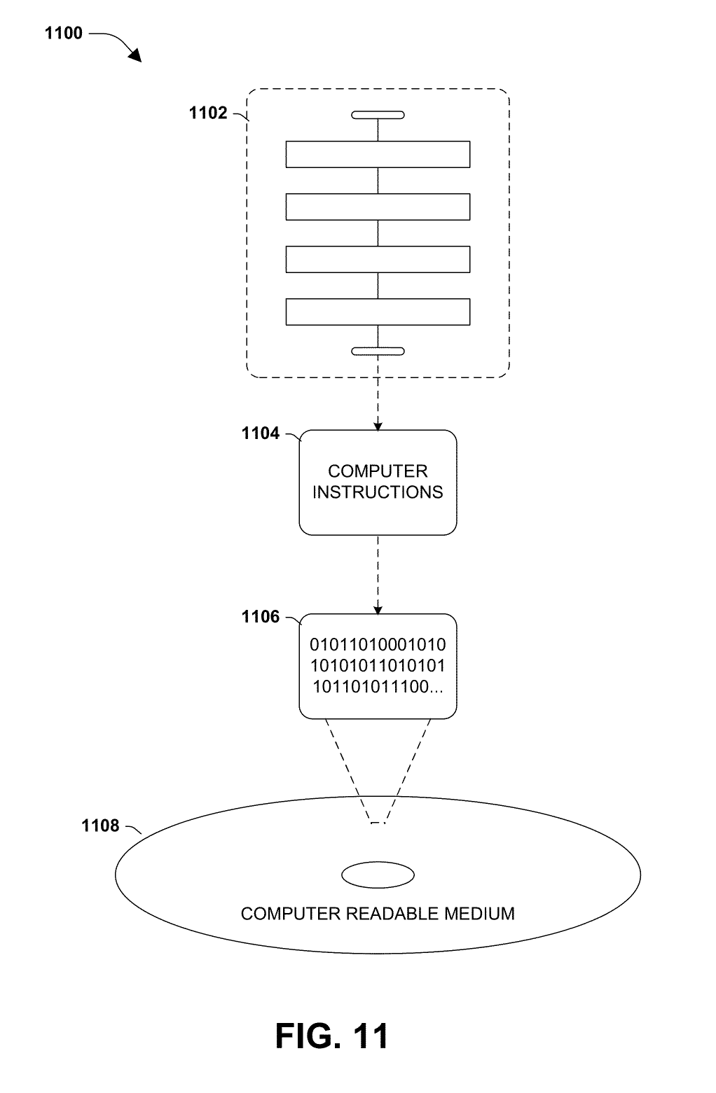

Still another embodiment involves a computer-readable medium comprising processor-executable instructions configured to implement one or more of the techniques presented herein. An example embodiment of a computer-readable medium or a computer-readable device is illustrated in FIG. 11, wherein the implementation 1100 comprises a computer-readable medium 1108, such as a CD-R, DVD-R, flash drive, a platter of a hard disk drive, etc., on which is encoded computer-readable data 1106. This computer-readable data 1106, such as binary data comprising at least one of a zero or a one, in turn comprises a set of computer instructions 1104 configured to operate according to one or more of the principles set forth herein. In some embodiments, the processor-executable computer instructions 1104 are configured to perform a method 1102, such as at least some of the exemplary method 100 of FIG. 1 and/or at least some of the exemplary method 200 of FIG. 2, for example. In some embodiments, the processor-executable instructions 1104 are configured to implement a system, such as at least some of the exemplary system 300 of FIG. 3, at least some of the exemplary system 400 of FIG. 4, at least some of the exemplary system 500 of FIG. 5, at least some of the exemplary system 600 of FIG. 6, at least some of the exemplary system 700 of FIG. 7, and/or at least some of the exemplary system 800 of FIG. 8, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

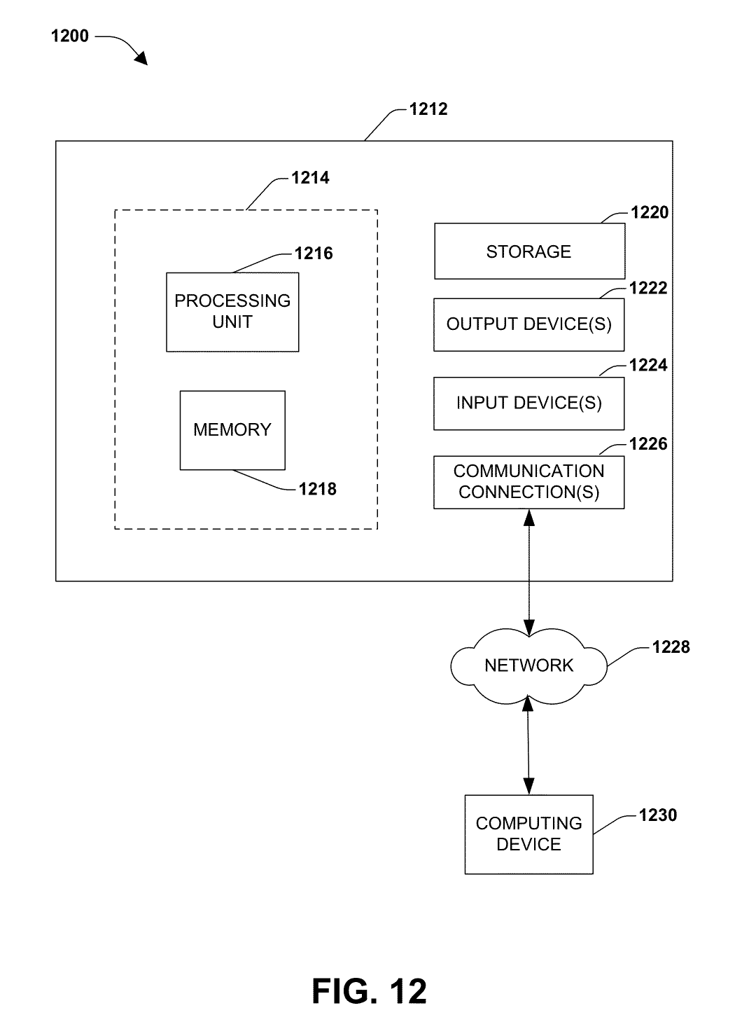

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 1200 comprising a computing device 1212 configured to implement one or more embodiments provided herein. In one configuration, computing device 1212 includes at least one processing unit 1216 and memory 1218. Depending on the exact configuration and type of computing device, memory 1218 may be volatile (such as RAM, for example), non-volatile (such as ROM, flash memory, etc., for example) or some combination of the two. This configuration is illustrated in FIG. 12 by dashed line 1214.

In other embodiments, device 1212 may include additional features and/or functionality. For example, device 1212 may also include additional storage (e.g., removable and/or non-removable) including, but not limited to, magnetic storage, optical storage, and the like. Such additional storage is illustrated in FIG. 12 by storage 1220. In one embodiment, computer readable instructions to implement one or more embodiments provided herein may be in storage 1220. Storage 1220 may also store other computer readable instructions to implement an operating system, an application program, and the like. Computer readable instructions may be loaded in memory 1218 for execution by processing unit 1216, for example.

The term “computer readable media” as used herein includes computer storage media. Computer storage media includes volatile and nonvolatile, removable and non-removable media implemented in any method or technology for storage of information such as computer readable instructions or other data. Memory 1218 and storage 1220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1212. Computer storage media does not, however, include propagated signals. Rather, computer storage media excludes propagated signals. Any such computer storage media may be part of device 1212.

Device 1212 may also include communication connection(s) 1226 that allows device 1212 to communicate with other devices. Communication connection(s) 1226 may include, but is not limited to, a modem, a Network Interface Card (NIC), an integrated network interface, a radio frequency transmitter/receiver, an infrared port, a USB connection, or other interfaces for connecting computing device 1212 to other computing devices. Communication connection(s) 1226 may include a wired connection or a wireless connection. Communication connection(s) 1226 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1212 may include input device(s) 1224 such as keyboard, mouse, pen, voice input device, touch input device, infrared cameras, video input devices, and/or any other input device. Output device(s) 1222 such as one or more displays, speakers, printers, and/or any other output device may also be included in device 1212. Input device(s) 1224 and output device(s) 1222 may be connected to device 1212 via a wired connection, wireless connection, or any combination thereof. In one embodiment, an input device or an output device from another computing device may be used as input device(s) 1224 or output device(s) 1222 for computing device 1212.

Components of computing device 1212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1212 may be interconnected by a network. For example, memory 1218 may be comprised of multiple physical memory units located in different physical locations interconnected by a network.

Those skilled in the art will realize that storage devices utilized to store computer readable instructions may be distributed across a network. For example, a computing device 1230 accessible via a network 1228 may store computer readable instructions to implement one or more embodiments provided herein. Computing device 1212 may access computing device 1230 and download a part or all of the computer readable instructions for execution. Alternatively, computing device 1212 may download pieces of the computer readable instructions, as needed, or some instructions may be executed at computing device 1212 and some at computing device 1230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for exposing one or more points of interest through a visual interface, comprising:
presenting a visual interface corresponding to a location displayed at a first level of detail;
clustering one or more points of interest associated with the location to generate one or more clustering halos, a first clustering halo comprising a first cluster of points of interest; and
populating the visual interface with the one or more clustering halos.

2. The method of claim 1, comprising:
responsive to receiving first focus input associated with the first clustering halo, transitioning the visual interface to display a first refined location displayed at a second level of detail to create a first transitioned visual interface;
clustering one or more points of interest within the first cluster of points of interest to generate one or more halos, a first halo comprising a first refined cluster of points of interest; and
populating the first transitioned visual interface with the one or more halos.

3. The method of claim 2, comprising:
responsive to receiving second focus input associated with a first point of interest within the first halo, modifying a display property of the first point of interest.

4. The method of claim 3, the modifying a display property comprising:
modifying a size of the first point of interest;
modifying an opaque property of the first point of interest;
modifying a color of the first point of interest; or
hydrating the first halo with imagery depicting the first point of interest.

5. The method of claim 2, the populating the first transitioned visual interface comprising:
displaying the first halo as a translucent halo.

6. The method of claim 2, comprising:
responsive to receiving second focus input associated with the first halo, transitioning the first transitioned visual interface to display a second refined location at a third level of detail to create a second transitioned visual interface; and
populating the second transitioned visual interface with one or more portals, a first portal corresponding to a first point of interest.

7. The method of claim 6, comprising:
responsive to receiving third focus input associated with the first portal, hydrating the first portal with imagery depicting the first point of interest.

8. The method of 7, the third focus input corresponding to at least one of a rollover input or a panning input positioning the first portal at a trigger zone within the second transitioned visual interface.

9. The method of claim 6, comprising:
responsive to receiving panning input:
for respective portals encountering a trigger zone of the second transitioned visual interface, hydrating a portal while the portal encounters the trigger zone and collapsing the portal responsive to the portal no longer encountering the trigger zone.

10. The method of claim 6, comprising:
responsive to receiving third focus input associated with the first portal, transitioning the second transitioned visual interface to display the first point of interest at a fourth level of detail to create a third transitioned visual interface.

11. The method of claim 10, comprising:
populating the third transitioned visual interface with one or more new portals.

12. The method of claim 2, comprising:
populating the first transitioned visual interface with a back interface element; and
responsive to invocation of the back interface element, transitioning the first transitioned visual interface to the visual interface.

13. The method of claim 1, the location corresponding to at least one of a single topic query or a multi-topic query.

14. The method of claim 7, the hydrating comprising:
hydrating the first portal with at least one of imagery associated with a user of the visual interface or imagery associated with one or more other users.

15. A method for exposing one or more points of interest through a visual interface, comprising:
presenting a visual interface corresponding to a location;
populating the visual interface with one or more portals, a first portal corresponding to a first point of interest for the location; and
responsive to receiving first focus input associated with the first portal, hydrating the first portal with imagery depicting the first point of interest.

16. The method of claim 15, the first focus input corresponding to at least one of a rollover input or a panning input positioning the first portal at a trigger zone within the visual interface.

17. The method of claim 15, comprising:
responsive to receiving second focus input associated with the first portal, transitioning the visual interface to display the first point of interest to create a first transitioned visual interface for a refined location.

18. The method of claim 17, comprising:
populating the first transitioned visual interface with one or more portals corresponding to points of interest within the refined location.

19. A system for exposing one or more points of interest through a visual interface, comprising:
a visualization component configured to:
present a visual interface corresponding to a location displayed at a first level of detail;
cluster one or more points of interest associated with the location to generate one or more clustering halos, a first clustering halo comprising a first cluster of points of interest; and
populate the visual interface with the one or more clustering halos.

20. The system of claim 19, the visualization component configured to:
responsive to receiving first focus input associated with the first clustering halo, transition the visual interface to display a first refined location displayed at a second level of detail to create a first transitioned visual interface;
cluster one or more points of interest within the first cluster of points of interest to generate one or more halos, a first halo comprising one or more portals, a first portal corresponding to a first point of interest;
populate the first transitioned visual interface with the one or more halos; and
responsive to receiving second focus input associated with the first portal, hydrate the first portal with imagery depicting the first point of interest; and
responsive to receiving selection input associated with the first portal, transition the first transitioned visual interface to display the first point of interest to create a second transitioned visual interface comprising one or more new portals corresponding to points of interest within the second transitioned visual interface.
